(19) United States
(12) Patent Application Publication
(10) Pub. No.: US 2023/0351035 A1
(43) Pub. Date: Nov. 2, 2023

(54) SYSTEM AND METHOD FOR USER-CONTROLLABLE SHARING OF AUTHORIZATION FOR PRIVATE DATA

(71) Applicant: Huazhong University of Science and Technology, Wuhan City (CN)

(72) Inventors: Weiqi DAI, Wuhan City (CN); Liangliang YU, Wuhan City (CN); Hai JIN, Wuhan City (CN); Deqing ZOU, Wuhan City (CN)

(21) Appl. No.: 17/937,995

(22) Filed: Oct. 4, 2022

(30) Foreign Application Priority Data
Apr. 29, 2022 (CN) 202210490126.6

(51) Int. Cl. G06F 21/62; G06F 21/60; H04L 9/08; H04L 9/06; H04L 9/32

(52) U.S. Cl. CPC G06F 21/6218; G06F 21/602; H04L 9/0822; H04L 9/0825; H04L 9/0618; H04L 9/3221; H04L 9/3297

(57) ABSTRACT

The present invention relates to system and method for user-controllable sharing of authorization for private data, wherein the system at least comprises: a blockchain node, for recording and verifying transaction information and/or completing payment, a client, for encrypting a symmetric key into a re-encryption key to be sent to an IPFS node, so that after a re-encryption request it sends to the IPFS node is verified as valid, the client sends the symmetric key to a server; the IPFS node, for calling a zero-knowledge proof verification contract from the blockchain node in response to the re-encryption request from the client, and performing authorization and verification; a server, for sending first encrypted data involving user authorization to the IPFS node, and/or acquiring the symmetric key sent by the client and capable of decrypting authorization data. In the present invention, the control of authorized contents is transferred to the user from the service provider, enabling the user to control authorization. Besides, during authorization, authorization data contents, data flows and user behaviors are hidden, making use of the data protected from pry of service providers.

This application claims the benefits of the Chinese Application No. CN202210490126.6 filed Apr. 29, 2022, which is hereby incorporated by reference as if fully set forth herein.

### BACKGROUND OF THE INVENTION

### Technical Field

The present invention relates to the technical field of blockchain, and more particularly to a system and method for user-controllable sharing of authorization for private data.

### Description of Related Art

Recently, data privacy has received increasing attention. Particularly, there are many noticeable “scandals” accused to be related to data abuse or breach. In 2018, Facebook, a major social medium platform, was involved in a scandal of data abuse. An article from New York Times accused that Facebook provided personal data of its users to 150 leading businesses all over the world for many years. Among these businesses, a British company named “Cambridge Analytica” is reported to acquire data from 87 million Facebook users by undue means and use analytic results of the data to push advertisement precisely that impacted the United States presidential election in 2016. It is thus clear that malicious collection and abuse of user data not only constitute serious privacy invasion, but also incur significant social consequence. There are many Internet companies in the world now, like Facebook, collecting user data unscrupulously, including use habits and preferences of users. While it is difficult to completely prevent such entities from accessing user data (such as user-generated contents or sensitive and personal information of users), protective measures can be designed and taken to maximize protection and minimize related risks.

This issue has drawn attention from some policy makers. For example, in May 2021, US Senator Klobuchar introduced S.1667—Social Media Privacy Protection and Consumer Rights Act of 2021, which requires that a network platform operator shall inform its user before he/she creates an account or uses the platform that the personal data generated as a result of his/her network behavior will be collected and used by the operator and third parties.

China Patent No. CN112685760A discloses a financial data privacy processing and sharing method capable of authorizing on block chain, which comprises combining a national secret SM4 algorithm and BGV-based homomorphic encryption to realize financial data privacy processing and multi-party or multi-stage sharing on an alliance chain, enabling financial institutions to share multi-party or multi-stage data on the alliance chain, enabling a data owner to carry out encryption protection on written data by using the national secret SM4 algorithm, then chaining and packaging, and enabling only authorized financial institutions to decrypt the data when ciphertext data need to be shared and authorized to other cooperators or application parties. According to the invention, the encrypted ciphertext of the authorizing party SM4 is converted into the new ciphertext of the data applying party under the full homomorphic encryption, so that the BaaS can be used for ensuring the safe processing and sharing of financial data, and simultaneously, the multi-stage sharing of the data is supported. However, since the prior invention uses fully homomorphic encryption, it is unavoidably limited by data storage capacity and execution efficiency.

China Patent No. CN112954000A discloses a privacy information management method and a system based on a block chain and IPFS technology. The system comprises a client, a blockchain system and an IPFS system. The client is for acquiring an access request from a user. The access request comprises a user ID and an access object. The blockchain system is for verifying whether the user has access right or not by inquiring a block chain account book; and if the access authority is provided, retrieving a hash record corresponding to the access object from the block chain account book. The client is further for accessing the access object stored in the IPFS according to the hash record. However, the prior patent provides merely a method for a user to access stored data, and mentions nothing about data sharing and authorization as well as personal data breach likely to happen in the process.

In addition, on the one hand, due to the differences in the understanding of those skilled in the art; on the other hand, due to the fact that the applicant studied a large amount of literature and patents when putting the invention, but space limitations do not allow all the details and content are described in detail, however, this does not mean that the invention does not have these prior art features, on the contrary, the present invention already has all the features of the prior art, and the applicant reserves the right to add relevant prior art to the background technology.

### SUMMARY OF THE INVENTION

To address the shortcomings of the prior art, the present invention provides a system for user-controllable sharing of authorization for private data, at least comprising:
a blockchain node, for recording and verifying transaction information and/or completing payment,
at least one client, for encrypting a symmetric key into a re-encryption key to be sent to an IPFS node, so that after a re-encryption request it sends to the IPFS node is verified as valid, the client sends the symmetric key to a server;
the IPFS node, for calling a zero-knowledge proof verification contract from the blockchain node in response to the re-encryption request from the client, and performing authorization and verification; and
at least one said server, for sending first encrypted data involving user authorization to the IPFS node, and/or acquiring the symmetric key sent by the client and capable of decrypting authorization data.

Preferably, the client is further for processing a symmetric key, a user stamp and/or a timestamp provided by the server into second encrypted data and updating the second encrypted data to the IPFS node.

Preferably, in response to the re-encryption request initiated by the client, the means of authorization and verification of the IPFS node comprises at least:
after the authorization and verification based on the zero-knowledge verification contract passes, computing the re-encryption key; or, otherwise, refusing the re-encryption request from the client.

In view of the shortcomings of the prior art, the present invention provides a system for user-controllable sharing of authorization for private data. This transfers control of authorized contents to the user from the service provider, enabling the user to control authorization. Besides, during authorization, authorization data contents, data flows and user behaviors are hidden, making use of the data protected from pry of service providers. The present invention well solves a series problems caused by the fact that the provider of data source acts as the only authorizing party, which not only participates in verification and authorization, but also controls sources and flows of data, so that user privacy is no more excessively dependent on service providers, thereby reducing the risk that dishonest or selfish service providers share privacy contents without explicit permission from users.

Preferably, in response to the re-encryption request initiated by the client, the means of authorization and verification of the IPFS node further comprises:
upon completion of computing the re-encryption key, calling a re-encryption verification contract by the IPFS node from the blockchain to verify correctness of a computing result; and
where the computing result about the re-encryption key is correct, uploading by the IPFS node the computing result about the re-encryption key to the IPFS node, or
where the computing result about the re-encryption key is incorrect, regarding by the IPFS node the computing result about the encryption request as being invalid and not to be uploaded.

Preferably, the client publishes a transaction of the authorization, and constructs a commitment protocol related to the authorization based on an authorization address; and the client, based on parameters including at least a user address, a data address and/or a key address, generates a non-interactive zero-knowledge proof that accords with the commitment protocol.

Preferably, the client is further for:
after obtaining the new, re-encrypted address, sending the data address and the new key address to the server,
so that the server is enabled to acquire first encrypted data according to the data address and the new key address, and decrypting the first encrypted data to obtain user authorization data.

Preferably, construction requirements of the zero-knowledge proof at least comprise:
based on the parameters including at least the data address, the key address, and the authorization passkey, constructing a commitment protocol identical with that constructed for authorization with a random number R used as a trapdoor;
constructing a commitment protocol that is bound to a user account using related authorization parameters with the user address used as a trapdoor; and
proving that the constructed commitment protocol exists in a Merkel tree formed by the commitment protocols.

The present invention further provides a method for user-controllable sharing of authorization for private data, at least comprising:
by the client, encrypting a symmetric key based on public and private keys, and generating a re-encryption key, so that a ciphertext and a re-encryption key address can be sent to an IPFS node;
by the IPFS node, after performing authorization and verification on the re-encryption key address, performing computing for re-encryption, so as to generate a new, re-encrypted ciphertext;
by the IPFS node, calling a re-encryption verification contract from a blockchain to verify correctness of the new, re-encrypted ciphertext;
by the server, after the result of the authorization and verification has been recognized, decrypting the ciphertext based on an assigned private key to obtain authorization data.

The user account includes at least blockchain accounts.

The said method further comprises:
the client publishes a transaction of the authorization, and constructs a commitment protocol related to the authorization based on an authorization address; and the client, based on parameters including at least a user address, a data address and/or a key address, generates a non-interactive zero-knowledge proof that accords with the commitment protocol and sends it to blockchain.

The present invention further provides a method for authorization and verification with authorization relation hidden, at least comprising:
by the client, publishing a transaction for authorization, and constructing a commitment protocol related to the authorization using an authorization address;
by the client, based on parameters including at least one user address, a data address and/or a key address, generating a non-interactive zero-knowledge proof commitment protocol that accords with the commitment protocol;
by the IPFS node, based on a re-encryption verification contract containing the zero-knowledge proof, verifying the validity of a re-encryption request initiated by the client; and
determining whether re-encryption as requested is to be performed based on the verification result of the re-encryption verification contract.

### BRIEF DESCRIPTION OF THE DRAWINGS

FIG. 1 shows simplified module connections in a system for user-controllable sharing of authorization for private data according to the present invention;

FIG. 2 is a simplified flowchart of publicly verifiable re-encryption sharing according to the present invention; and

FIG. 3 is a structural diagram of a zero-knowledge proof in authorization and verification according to the present invention.

### DETAILED DESCRIPTION OF THE INVENTION

The present invention will be further detailed below with reference to accompanying drawings.

A blockchain is a distributed ledger or shared database. Data stored therein have the following characteristics: open transparency, collective maintenance, incorrigibility, and traceability. From the perspective of data, a blockchain is an almost incorruptible distributed data. Herein, this distributedness is not only about distributed storage of data, but also about distributed records of data. Technically, the blockchain technology is a combination of many technologies, but not a new, single technology. These technologies are integrated in a new form to provide a new data structure for recording and storing data. Every block is composed by a block head and a block body. A block head usually contains some basic information of this block, such as the version number, records of the previous block, the Merkle-tree root value, timestamps, target feature values, random numbers, etc. A block body is composed by some transactions. These transactions are signed by the user with his/her private key and verified using the public key. A Merkle tree is usually used to generate the Hash values of all transactions in this block, so as to reduce the storage overheads of the chain. A block further comprises the hash value of its immediately previous block, so that the two blocks can be linked.

An IPFS (Inter-Planetary File System) is a new generation of communication protocol against Http based on a content addressing, versioning, peer-to-peer hypermedia transmission protocol, and in combination with the P2P network technology, the BitTorrent transmission technology, Git version control, and the self-certifying file system technology. An IPFS allows participants of a network to store, access, and transmit verifiable data from and to each other. Its objective is to make the Internet opener, faster, and safer. It uses a distributed hash table to address problems about data transmission and addressing, and turns one-to-one transmission into P2P (may-to-many) transmission, in which data are stored in hash chains.

A server is a use terminal of a service provider that directly provides mobile Internet service contents, and applications, while building data service systems, collecting, processing, and storing information, providing regular maintenance, and updating, and providing users with information contents through networks.

A client is a use terminal of a user.

Proxy re-encryption is an encryption technology that converts ciphertexts in a secure way. During proxy re-encryption, a ciphertext encrypted using the public key of an authorizer is converted to a different ciphertext, while the corresponding plaintext remains unchanged. The converted ciphertext may be decrypted using the private key of the authorizer. The ciphertext conversion is conducted by a semi-trusted agent, and before conversion, the agent has to possess a conversion key from the authorizer to an authorize. The conversion key is generally generated by the authorizer in advance and handed to the agent. Throughout the process of conversion of the ciphertext, the agent is unable to acquire any information about the plaintext corresponding to the ciphertext.

A zero-knowledge proof is for a prover to convince a verifier that a certain statement is correct without providing any useful information to the verifier. The prover proves to the verifier that the prover knows or has some message but the prover cannot disclose any information about the proven message to the verifier. At last, the verifier can prove that some interaction between the prover and the verifier can fundamentally reduce the knowledge volume that has to be transmitted between the two parties. The proof algorithm is focused on information disclosure. In other words, the issue is how much information is disclosed to the verifier for it to verify whether a statement is true.

### Embodiment 1

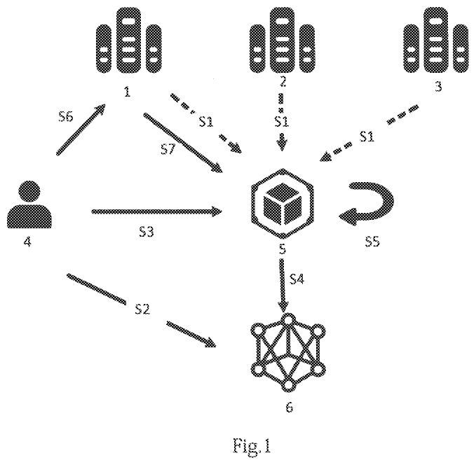

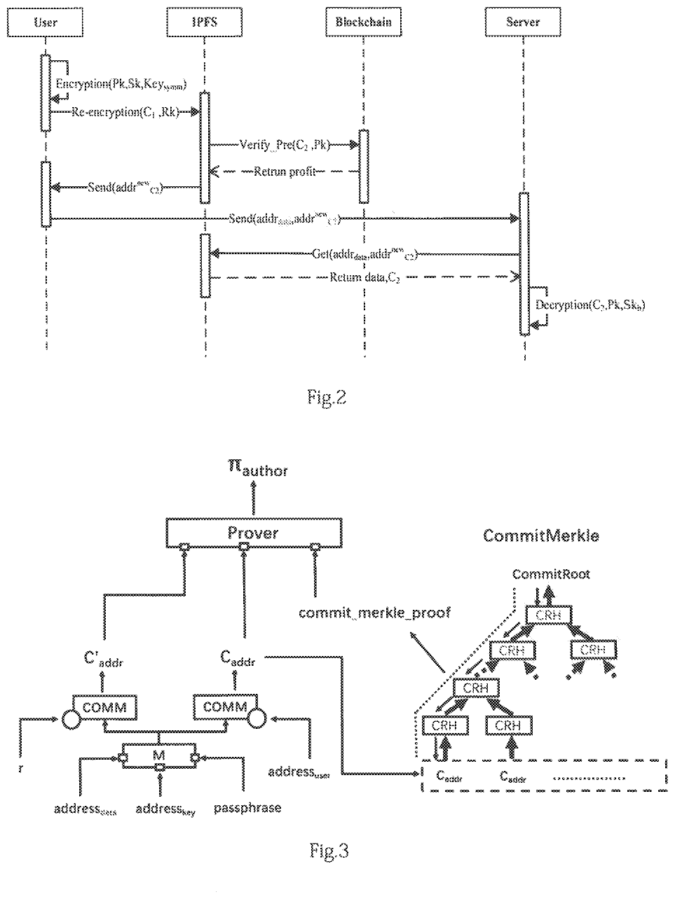

The system for user-controllable sharing of authorization for private data of the present invention comprises at least one server, at least one client 4, IPFS nodes 5, and at least one blockchain node 6. Referring to FIG. 1, in the depicted embodiment, there are a first server 1, a second server 2, and a third server 3.

The servers store data involving user authorization in a distributed IPFS instead of centralized storage as implemented in the prior art. The servers may be application specific IC chips, processors, and/or servers capable of distributed storage.

The client 4 is used to conduct on-chain authorization for authorization data and issue a re-encryption request to the IPFS nodes. The client at least comprises an electronic device capable of re-encryption, or specifically, an electronic device capable of operating a re-encryption program. An electronic device can be used as the client may be an application specific IC chip, a server, a computer, or a portable, mobile terminal having a chip or a processor, and they are capable of re-encryption. The portable, mobile terminal may be for example, smart glasses, a smart watch, a smart VR device, a smart bracelet, a mobile computer, etc.

The IPFS nodes 5 store some user data contents, receive re-encryption request from users, and conduct authorization and verification on a blockchain network. After verification, the IPFS nodes 5 compute data for re-encryption, and then conduct verification for the re-encryption after computing on the blockchain. The IPFS nodes 5 may be servers, processors, and/or application specific IC chips supporting the foregoing functions. The IPFS nodes 5 are further capable of storage.

To be specific, the servers, processors, and/or application specific IC chips, by executing corresponding encoding programs, can implement functions including: storing part of user data contents, receiving re-encryption requests from users, conducting authorization and verification on the blockchain network; after verification, computing data for re-encryption, and conducting further verification for re-encryption on the blockchain.

The blockchain 6 is used to maintain the blockchain network, to broadcast and record and verify transactions, and to accomplish payment. The blockchain 6 is composed of several blockchain nodes that are in information communication with each other, and is the collocative representation of these blockchain nodes. The blockchain nodes may be processors, servers and/or groups of servers capable of broadcasting and verifying transactions, and processing payment contents. To be specific, processors, servers and/or groups of servers, by executing corresponding encoding programs, can implement the functions of broadcasting, recording and verifying transactions and accomplishing payment of the blockchain 6.

The method for user-controllable sharing of authorization for private data of the present invention at least comprises the steps S1 to S7, as detailed below.

S1 is initialization of the system.

The server uses an IPFS distributed network to store user data to be shared.

Every server is assigned with a public-private key pair for proxy re-encryption. The public-private key pair assigned to the server needs only regular updating but not frequent change. For user data, the server uses different symmetry encrypting key to encrypt different parts and generate first encrypted data, which are then uploaded to the IPFS node. The symmetric key is sent to the client 4 corresponding to the user through a secure channel.

The client 4 is also assigned with a public-private key pair for proxy re-encryption. Different from the server, the client 4 gets a new public-private key pair for every time of re-encryption, and the public-private key pair can be deleted immediately after use. After acquiring the symmetric key, the client 4 may add a designated user stamp or timestamp to the symmetric key, and encrypt it to generate a second encrypted data that is then uploaded to the IPFS node 5. Besides, the client 4 has to locally maintain an address table to record the correspondence between data addresses and the related key addresses.

At S2, the client 4 issues authorization transaction information and performs authorization for the related data.

The authorization transaction contains an information commitment protocol related to data addresses that is used for subsequent verification of authorization.

The information commitment protocol can issue a commitment protocol C related to m without exposing any m information about the user, and prove that the commitment protocol C is a commitment bound to the information m by disclosing a trapdoor r.

The client 4 constructs the information commitment protocol using at least the data address, the key address (the symmetry encrypting key) and/or the authorization passkey as hidden information, and proves the authorization from the user about the data by means of disclosing the commitment protocol C, without exposing information about the data address, the key address, and the authorization passkey. Meanwhile, for facilitating subsequent proof of existence of the commitment protocol C without exposing the commitment protocol C, there is a need for a global commitment tree. The present invention stores the commitment protocol C using a Merkle tree, so that existence of a leaf node commitment protocol C in the tree can be achieved by proving merely a hash route from the leaf node to a root node.

At S3, the client 4 issues a re-encryption request to the IPFS node 5, and uploads records of the request to the chain, and makes the corresponding payments.

The client 4 generates the commitment protocol C published upon authorization to prove that it does know the data address, the key address, and the authorization passkey. In order to prevent a malicious client launching a replay attack from passing verification, the proof has to be bound to the current address of the client. In other words, a new commitment protocol C′ has to be published and the user address is used as the trapdoor.

During verification, since the key address is necessarily exposed, the commitment protocol C and the new commitment protocol C′ have to be hidden and invisible so as not to expose authorization relationship.

In addition, for ensuring validity of the commitment protocol C, the proof must include a requirement that the commitment protocol C has to exist in the commitment tree. A zero-knowledge proof is constructed on the basis of the requirement and then the generated proof is sent to the IPFS node 5 with the re-encryption request.

Every re-encryption request is uploaded to and stored in the blockchain 6, and the user has to pay for this through the client 4.

At S4, the IPFS node 5 calls the zero-knowledge proof to verify the re-encryption verification contract.

The IPFS node 5, in response to the re-encryption request from the client 4, conduct authorization and verification on the blockchain 6 according to the proof provided by the client 4. If the verification fails, no computing for re-encryption will be conducted. Only when verification of the authorization successes, can the corresponding IPFS node 5 perform computing for re-encryption.

At S5, the IPFS node 5 conducts proxy re-encryption, and calls the re-encryption verification contract to conduct computing and verification.

After the authorization and verification, the IPFS node 5 directly performs proxy computing on the ciphertext for re-encryption. The computing is added to the underlying functions of the IPFS node 5 so as to increase a re-encryption function without breaking the underlying storage network of the IPFS node 5, thereby allowing the computing to be performed directly on the IPFS node 5. Given that simple conversion of ciphertext is insufficient to satisfy the requirements of verification, the present invention adopts the concept of a signcryption scheme to convert the ciphertext into the form of a signcryption text, which means that a signature verification is embedded into the ciphertext for allowing the computing result to be publicly verified. If the verification successes, the IPFS node 5 uploads the new ciphertext to the IPFS network and sends the new ciphertext address to the client 4, so as to receive corresponding profit. Otherwise, the computing result is not recognized.

At S6, the client 4 sends the data addresses and the re-encrypted new ciphertext address to the server.

After the computing result of the re-encryption key passes verification, the client 4 can receive the re-encrypted, new ciphertext address from the IPFS node 5, and can send the data address to the server.

At S7, the server uses its own private key to do decryption and acquire the key and the data.

After obtaining the re-encrypted new ciphertext address, the server may obtain the re-encrypted ciphertext through the IPFS network. With the re-encrypted ciphertext in hand, the server can use its private key to do decryption and thereby acquire the symmetric key. Meanwhile, for ensure integrity and security of data during transmission, the decryption process includes further verification for the re-encrypted ciphertext. Only when verification successes, can the server trust and get the correct key. Afterward, the server can use the symmetric key to decrypt the ciphertext and get the authorization data.

It should be noted that the above-mentioned specific embodiments are exemplary, and those skilled in the art can come up with various solutions inspired by the disclosure of the present invention, and those solutions also fall within the disclosure scope as well as the protection scope of the present invention. It should be understood by those skilled in the art that the description of the present invention and the accompanying drawings are illustrative rather than limiting to the claims. The protection scope of the present invention is defined by the claims and their equivalents. The description of the present invention contains a number of inventive concepts, such as “preferably”, “according to a preferred embodiment” or “optionally”, and they all indicate that the corresponding paragraph discloses an independent idea, and the applicant reserves the right to file a divisional application based on each of the inventive concepts.

What is claimed is:

1. A system for user-controllable sharing of authorization for private data, at least comprising:
a client, for encrypting a symmetric key based on public and private keys, and generating a re-encryption key, so that a ciphertext and a re-encryption key address can be sent to an IPFS node by the client;
the IPFS node, for performing authorization and verification on the re-encryption key address and performing computing for re-encryption, so as to generate a new, re-encrypted ciphertext, and calling a re-encryption verification contract from a blockchain to verify correctness of the new, re-encrypted ciphertext;
a server, for, after the result of the authorization and verification has been recognized, decrypting the ciphertext based on an assigned private key to obtain authorization data; and
a blockchain node, for recording and verifying transaction information and/or completing payment.

2. The system for sharing of authorization for private data according to claim 1, wherein the client is further for processing a symmetric key, a user stamp and/or a timestamp provided by the server into second encrypted data and updating the second encrypted data to the IPFS node.

3. The system for sharing of authorization for private data according to claim 2, wherein, in response to the re-encryption request initiated by the client, the means of authorization and verification of the IPFS node comprises at least:
after the authorization and verification based on the zero-knowledge verification contract passes, computing the re-encryption key; or, otherwise, refusing the re-encryption key from the client.

4. The system for sharing of authorization for private data according to claim 3, wherein, in response to the re-encryption request initiated by the client, the means of authorization and verification of the IPFS node further comprises:
upon completion of computing the re-encryption key, calling a re-encryption verification contract by the IPFS node from the blockchain to verify correctness of a computing result; and
where the computing result about the re-encryption key is correct, uploading by the IPFS node the computing result about the re-encryption key to the IPFS node, or
where the computing result about the re-encryption key is incorrect, regarding by the IPFS node the computing result about the encryption request as being invalid and not to be uploaded.

5. The system for sharing of authorization for private data according to claim 4, wherein, the client publishes a transaction of the authorization, and constructs a commitment protocol related to the authorization based on an authorization address; and the client, based on parameters including at least a user address, a data address and/or a key address, generates a non-interactive zero-knowledge proof that accords with the commitment protocol.

6. The system for sharing of authorization for private data according to claim 5, wherein the client is further for:
after obtaining the new, re-encrypted address, sending the data address and the new key address to the server,
so that the server is enabled to acquire first encrypted data according to the data address and the new key address, and decrypting the first encrypted data to obtain user authorization data.

7. The system for sharing of authorization for private data according to claim 6, wherein construction requirements the zero-knowledge proof at least comprises:
based on the parameters including at least the data address, the key address, and the authorization passkey, constructing a commitment protocol identical with that constructed for authorization with a random number R used as a trapdoor;
constructing a commitment protocol that is bound to a user account using related authorization parameters with the user address used as a trapdoor; and
proving that the constructed commitment protocol exists in a Merkel tree formed by the commitment protocols.

8. A method for user-controllable sharing of authorization for private data, at least comprising:
by the client, encrypting a symmetric key based on public and private keys, and generating a re-encryption key, so that a ciphertext and a re-encryption key address can be sent to an IPFS node;
by the IPFS node, after performing authorization and verification on the re-encryption key address, performing computing for re-encryption, so as to generate a new, re-encrypted ciphertext;
by the IPFS node, calling a re-encryption verification contract from a blockchain to verify correctness of the new, re-encrypted ciphertext;
by the server, after the result of the authorization and verification has been recognized, decrypting the ciphertext based on an assigned private key to obtain authorization data.

9. The method for user-controllable sharing of authorization for private data in claim 8, further comprising:
the client publishes a transaction of the authorization, and constructs a commitment protocol related to the authorization based on an authorization address; and the client, based on parameters including at least a user address, a data address and/or a key address, generates a non-interactive zero-knowledge proof that accords with the commitment protocol and sends it to blockchain.

10. The method for sharing of authorization for private data according to claim 9, wherein the client is further for processing a symmetric key, a user stamp and/or a timestamp provided by the server into second encrypted data and updating the second encrypted data to the IPFS node.

11. The method for sharing of authorization for private data according to claim 10, wherein, in response to the re-encryption request initiated by the client, the means of authorization and verification of the IPFS node comprises at least:
after the authorization and verification based on the zero-knowledge verification contract passes, computing the re-encryption key; or, otherwise, refusing the re-encryption key from the client.

12. The method for sharing of authorization for private data according to claim 11, wherein, in response to the re-encryption request initiated by the client, the means of authorization and verification of the IPFS node further comprises:
upon completion of computing the re-encryption key, calling a re-encryption verification contract by the IPFS node from the blockchain to verify correctness of a computing result; and
where the computing result about the re-encryption key is correct, uploading by the IPFS node the computing result about the re-encryption key to the IPFS node, or
where the computing result about the re-encryption key is incorrect, regarding by the IPFS node the computing result about the encryption request as being invalid and not to be uploaded.

13. The system for sharing of authorization for private data according to claim 12, wherein, the client publishes a transaction of the authorization, and constructs a commitment protocol related to the authorization based on an authorization address; and the client, based on parameters including at least a user address, a data address and/or a key address, generates a non-interactive zero-knowledge proof that accords with the commitment protocol.

14. The method for sharing of authorization for private data according to claim 13, wherein the client is further for:
after obtaining the new, re-encrypted address, sending the data address and the new key address to the server,
so that the server is enabled to acquire first encrypted data according to the data address and the new key address, and decrypting the first encrypted data to obtain user authorization data.

15. The method for sharing of authorization for private data according to claim 14, wherein construction requirements the zero-knowledge proof at least comprises:
based on the parameters including at least the data address, the key address, and the authorization passkey, constructing a commitment protocol identical with that constructed for authorization with a random number R used as a trapdoor;
constructing a commitment protocol that is bound to a user account using related authorization parameters with the user address used as a trapdoor; and
proving that the constructed commitment protocol exists in a Merkel tree formed by the commitment protocols.

16. A method for authorization and verification with authorization relation hidden, at least comprising:
by the client, publishing a transaction for authorization, and constructing a commitment protocol related to the authorization using an authorization address;
by the client, based on parameters including at least one user address, a data address and/or a key address, generating a non-interactive zero-knowledge proof commitment protocol that accords with the commitment protocol;
by the IPFS node, based on a re-encryption verification contract containing the zero-knowledge proof, verifying the validity of a re-encryption request initiated by the client; and
determining whether re-encryption as requested is to be performed based on the verification result of the re-encryption verification contract.

17. The method for authorization and verification with authorization relation hidden of claim 16, wherein the client is further for processing a symmetric key, a user stamp and/or a timestamp provided by the server into second encrypted data and updating the second encrypted data to the IPFS node.

18. The method for authorization and verification with authorization relation hidden of claim 17, wherein, in response to the re-encryption request initiated by the client, the means of authorization and verification of the IPFS node comprises at least:
after the authorization and verification based on the zero-knowledge verification contract passes, computing the re-encryption key; or, otherwise, refusing the re-encryption key from the client.

19. The method for authorization and verification with authorization relation hidden of claim 18, wherein, in response to the re-encryption request initiated by the client, the means of authorization and verification of the IPFS node further comprises:
upon completion of computing the re-encryption key, calling a re-encryption verification contract by the IPFS node from the blockchain to verify correctness of a computing result; and
where the computing result about the re-encryption key is correct, uploading by the IPFS node the computing result about the re-encryption key to the IPFS node, or
where the computing result about the re-encryption key is incorrect, regarding by the IPFS node the computing result about the encryption request as being invalid and not to be uploaded.

20. The method for authorization and verification with authorization relation hidden of claim 19, wherein, the client publishes a transaction of the authorization, and constructs a commitment protocol related to the authorization based on an authorization address; and the client, based on parameters including at least a user address, a data address and/or a key address, generates a non-interactive zero-knowledge proof that accords with the commitment protocol.
